(19) United States
(12) Patent Application Publication
(10) Pub. No.: US 2024/0021791 A1
(43) Pub. Date: Jan. 18, 2024

(54) POSITIVE ELECTRODE ACTIVE MATERIAL POWDER, POSITIVE ELECTRODE, LITHIUM ION BATTERY, AND METHOD FOR PRODUCING POSITIVE ELECTRODE ACTIVE MATERIAL POWDER

(71) Applicant: TOYOTA JIDOSHA KABUSHIKI KAISHA, Toyota-shi (JP)

(72) Inventor: Kenji YOKOE, Toyota-shi (JP)

(21) Appl. No.: 18/303,686

(22) Filed: Apr. 20, 2023

(30) Foreign Application Priority Data
Jul. 14, 2022 (JP) 2022-113229

(51) Int. Cl. H01M 4/36; H01M 4/485; H01M 10/0525; H01M 4/131; H01M 4/525; H01M 4/505; H01M 4/1315; C01G 53/00

(52) U.S. Cl. CPC H01M 4/364; H01M 4/485; H01M 10/0525; H01M 4/131; H01M 4/525; H01M 4/505; H01M 4/1315; C01G 53/50; H01M 2004/028

(57) ABSTRACT

The positive electrode active material powder includes a lithium nickel composite oxide and a lithium tungsten composite oxide. A ratio of an amount of substance of Ni to a total amount of substance of atoms other than Li and oxygen in the lithium nickel composite oxide is 0.5 or more. The lithium tungsten composite oxide is adhered to at least a portion of a surface of the lithium nickel composite oxide. 30% or more of the lithium tungsten composite oxide consists of a Li₄WO₅ phase.

### CROSS-REFERENCE TO RELATED APPLICATION

This application claims priority to Japanese Patent Application No. 2022-113229 filed on Jul. 14, 2022, incorporated herein by reference in its entirety.

### BACKGROUND

### 1. Technical Field

The present disclosure relates to a positive electrode active material powder, a positive electrode, a lithium ion battery, and a method for producing the positive electrode active material powder.

### 2. Description of Related Art

Japanese Unexamined Patent Application Publication No. 2021-018895 (JP 2021-018895 A) discloses a coating containing tungsten oxide and lithium tungstate.

### SUMMARY

A high output of a lithium ion battery (hereinafter may be abbreviated as a “battery”) is required. For example, when a positive electrode active material powder is crushed, the specific surface area of the positive electrode active material powder can be increased. Due to an increase in the specific surface area, it is expected that the reaction area is increased and an output is improved.

However, a new surface can be generated when the positive electrode active material powder is crushed. The new surface is active. During high-temperature storage, the capacity degradation may be accelerated by the reaction between the new surface and the electrolyte. That is, the capacity retention rate can decrease.

Therefore, an object of the present disclosure is to improve the capacity retention rate.

A technical configuration and effects of the present disclosure will be described below. However, an effect mechanism of the present specification includes speculation. The effect mechanism does not limit the technical scope of the present disclosure.

1. A positive electrode active material powder includes: lithium nickel composite oxide; and lithium tungsten composite oxide. A ratio of an amount of substance of Ni to a total amount of substance of atoms other than Li and oxygen in the lithium nickel composite oxide is 0.5 or more. The lithium tungsten composite oxide is adhered to at least a portion of a surface of the lithium nickel composite oxide. 30% or more of the lithium tungsten composite oxide consists of a Li₄WO₅ phase.

Hereinafter, the lithium nickel composite oxide can be abbreviated as “LNO”. The lithium tungsten composite oxide can be abbreviated as “LWO”. The ratio of the amount of substance of Ni to the total amount of substance of atoms other than Li and oxygen in LNO can be abbreviated as a “Ni ratio”.

Conventionally, it has been proposed to cover the surface of LNO with LWO by subjecting the mixture of LNO and LWO₃ to a heat treatment. LWO can have a protective effect on the new surface. That is, LWO can inhibit the reaction between the new surface and the electrolyte. The main phase of LWO is usually a Li₂WO₄ phase.

LNO having the Ni ratio of 0.5 or more can also be referred to as a “high nickel material.” When the high nickel material is crushed, a large amount of active Li can be generated in the new surface. According to the new findings disclosed in the present disclosure, in a Li-rich reaction system, the generation of the Li₄WO₅ phase can be promoted as compared with the generation of the Li₂WO₄ phase. The Li₄WO₅ phase has an excellent protective effect during high-temperature storage as compared with the Li₂WO₄ phase. When the composition ratio of the Li₄WO₅ phase becomes 30% or more in LWO, the capacity retention rate during high-temperature storage is expected to be improved.

2. In the positive electrode active material powder according to “1”, the lithium tungsten composite oxide may include, for example, 54% or more of the Li₄WO₅ phase and a remainder of a Li₂WO₄ phase.

When the composition ratio of the Li₄WO₅ phase is 54% or more, the capacity retention rate is expected to be improved.

3. In the positive electrode active material powder according to “1” or “^{2”}, the lithium nickel composite oxide may be represented by the following formula (1), for example:

Li₍₁₊ₓ₎Ni_{y}Co_{z}Mn_{(1-y-z)}MₐO_{(2-b)}C_{b} (1).

In the above formula (1), x, y, z, a, and b satisfy relationships of 0≤x≤0.7, 0.5≤y≤0.8, 0.1≤z≤0.2, 0≤a≤0.1, and 0≤b≤0.5, respectively.
M is at least one selected from the group consisting of Zr, Mo, W, Mg, Ca, Na, Fe, Cr, Zn, Si, Sn, Al, and Ag.
C is at least one selected from the group consisting of F, Cl, and Br.

4. A coverage rate of the surface of the lithium nickel composite oxide with the lithium tungsten composite oxide may be, for example, 11% to 25%.

The coverage rate is obtained using the following formula (2):

θ=r_{w}/(r_{w}+r_{Ni}+r_{Co}+r_{Mn}) (2).

In the above formula (2), θ represents the coverage rate. r_{w}, r_{Ni}, r_{Co}, and r_{Mn} are measured by X-ray photoelectron spectroscopy. r_{w} represents an atomic ratio of W. r_{Ni} represents an atomic ratio of Ni. r_{Co} represents an atomic ratio of Co. r_{Mn} represents an atomic ratio of Mn.

Hereinafter, the “coverage rate of the surface of LNO with LWO” can be abbreviated as the “coverage rate”. In a rage of the coverage rate of 11% to 25%, the Li₄WO₅ phase tends to be generated.

5. The positive electrode active material powder according to any one of “1” to “4” may have D50 of, for example, 1.2 μm to 2.7 μm.

When the D50 is 1.2 μm to 2.7 μm, the Li₄WO₅ phase tends to be generated.

6. A positive electrode includes the positive electrode active material powder according to any one of “1” to “5”.

7. A lithium ion battery includes the positive electrode according to “6”.

8. A method for producing a positive electrode active material powder includes the following (a) to (c):
(a) preparing a crushed powder by crushing lithium nickel composite oxide;
(b) preparing a mixture by mixing the crushed powder and WO₃; and
(c) producing the positive electrode active material powder by subjecting the mixture to a heat treatment.
   The positive electrode active material powder includes the lithium nickel composite oxide and lithium tungsten composite oxide. A ratio of an amount of substance of Ni to a total amount of substance of atoms other than Li and oxygen in the lithium nickel composite oxide is 0.5 or more. The lithium tungsten composite oxide is adhered to at least a portion of a surface of the lithium nickel composite oxide. 30% or more of the lithium tungsten composite oxide consists of a Li₄WO₅ phase.

Hereinafter, embodiments of the present disclosure (hereinafter can be abbreviated as the “present embodiment”) and examples of the present disclosure (hereinafter can be abbreviated as the “present example”) will be described. However, the present embodiment and the present example do not limit the technical scope of the present disclosure. The present embodiment and the present example are illustrative in all respects. The present embodiment and the present example are not restrictive. The technical scope of the present disclosure includes all changes within the meaning and range equivalent to the description of the claims. For example, from the beginning, it is planned to extract an appropriate configuration from the present embodiment and the present example and combine them as appropriate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic flow chart of a process for producing a positive electrode active material powder according to the present embodiment; and

FIG. 2 is a conceptual diagram of a lithium ion battery according to the present embodiment.

### DETAILED DESCRIPTION OF EMBODIMENTS

Terms and Definitions, Etc.

Statements of “comprising,” “including,” and “having,” and variations thereof (for example “composed of”) are open-ended formats. The open-ended format may or may not include an additional element in addition to a required element. A statement of “consisting of” is a closed format. However, even when the statement is the closed format, normally associated impurities and additional elements irrelevant to the disclosed technique are not excluded. A statement “substantially consisting of” is a semi-closed format. The semi-closed format allows addition of an element that does not substantially affect the basic and novel characteristics of the disclosed technique.

Expressions such as “may” and “can” are used in the permissive sense of “having the possibility of” rather than in the obligatory sense of “must”.

For example, a numerical range such as “m % to n %” includes an upper limit value and a lower limit value. That is, “m % to n %” indicates a numerical range of “m % or more and n % or less”. In addition, “m % or more and n % or less” includes “more than m % and less than n %”. Further, a numerical value selected as appropriate from within the numerical range may be used as a new upper limit value or a new lower limit value. For example, a new numerical range may be set by appropriately combining numerical values within the numerical range with numerical values described in other parts of the present specification, tables, drawings, and the like.

For multiple steps, actions, operations, and the like included in various methods, the execution order thereof is not limited to the described order unless otherwise specified. For example, the multiple steps may proceed concurrently. For example, the multiple steps may occur one after the other.

All numerical values are modified by the term “approximately.” The term “approximately” can mean, for example, ±5%, 3%, ±1%, and the like. All numerical values can be approximations that may vary depending on the mode of use of the disclosed technique. All numerical values can be displayed with significant digits. A measured value can be an average value of multiple measurements. The number of measurements may be three or more, five or more, or ten or more. In general, it is expected that the reliability of the average value improves as the number of measurements increases. The measured value can be rounded by rounding based on the number of significant digits. The measured value can include errors and the like associated with, for example, the detection limit of a measuring device.

When a compound is represented by a stoichiometric composition formula (for example, “LiCoO₂”), the stoichiometric composition formula is only a representative example of the compound. The compound may have a non-stoichiometric composition. For example, when lithium cobalt oxide is expressed as “LiCoO₂”, unless otherwise specified, the lithium cobalt oxide is not limited to a composition ratio of “Li/Co/O=1/1/2”, and can include Li, Co and O in any composition ratio. Further, doping with trace elements, substitution, etc. can also be permitted.

“D50” indicates a particle size in which the cumulative frequency from the smaller particle size reaches 50% in the volume-based particle size distribution. The particle size distribution can be measured by a laser diffraction particle size distribution measuring apparatus. The measurement sample can be prepared by dispersing the powder in water by sonication.

Li₄WO₅ Phase, Li₂WO₄ Phase Composition Ratio

The composition ratio of Li₄WO₅ phase and Li₂WO₄ phase in LWO can be determined by analyzing the spectrum (X-ray Absorption Fine Structure (XAFS) of the positive electrode active material powder). Examples of facilities capable of measuring XAFS spectra include a beamline “BL5S1” of “Aichi Synchrotron Optical Center”.

The normal spectrum of Li₄WO₅ is measured in the following manner. A blend of LiOH and WO₃ may be heat treated at 950° C. for 10 hours to produce Li₄WO₅. Mixtures are prepared by mixing 1 part by weight of Li₄WO₅ and 99 parts by weight of boron nitride by means of a dancing mill. The tablet molding machine presses the mix at a 30 kN pressure to form a pelletized sample. For example, a hydraulic press or the like may be used. A pellet sample is placed on the stage. The transmission method measures XAFS spectrum of Li₄WO₅.

The normal spectrum of Li₂WO₄ is measured in the following manner. A powder of commercially available Li₂WO₄ (e.g., manufactured by Kishida Chemical Co., Ltd.) is prepared. As described above, a pelleted sample containing Li₂WO₄ and boron nitride is prepared. The transmission method measures XAFS spectrum of Li₂WO₄.

In the same manner as described above, a pellet sample containing a measurement target (positive electrode active material powder) and boron nitride is produced. Note that, for example, instead of the pellet sample, an electrode (positive electrode) containing a positive electrode active material powder, a conductive material, a binder, and the like may be used as the measurement sample. XAFS spectrum of the positive electrode active material powder is measured by a fluorescent method.

XAFS spectrum is analyzed by XAFS analysis software “Athena”. XAFS spectrum of the positive electrode active material powder is fitted to the standard spectrum of Li₄WO₅ and the standard spectrum of Li₂WO₄. Thus, the composition ratio of Li₄WO₅ phase and the composition ratio of Li₂WO₄ phase in the positive electrode active material powder can be specified.

Coverage Rate

The coverage is determined by X-ray Photoelectron Spectroscopy (XPS). For example, the XPS device “product name: PHIX-tool” available from ULVAC-PHI, Inc. (or equivalent thereto) may be used. The positive electrode active material powder is set in XPS device. Narrow scan analysis is performed. The measurement data is processed by an analysis software. For example, the analysis software “product name: MulTiPak” available from ULVAC-PHI, Inc. (or equivalent thereto) may be used. W4f_{7/2}, Ni2p_{3/2}, Co2p_{3/2}, Mn2p_{3/2} of the atomic ratio of each atom is determined from the area of each peak. The coverage ratio is determined by the following formula (2). The coverage is expressed as a percentage.

θ=r_{w}/(r_{w}+r_{Ni}+r_{Co}+r_{Mn}) (2).

In the above formula (2), θ represents a coverage ratio (%). r_{w} represents the atomic ratio of W. r_{Ni} represents the atomic ratio of Ni. r_{Co} represents the atomic ratio of Co. r_{Mn} represents the atomic ratio of Mn.

Positive Electrode Active Material Powder

The positive electrode active material powder is an aggregate of particles. The positive electrode active material powder has a large proportion of fine particles and may have a large specific surface area. By using the positive electrode active material powder, the reaction area at the time of energization is increased, and the output is expected to be improved.

Particle Size Distribution

D50 of the positive electrode active material powder may be, for example, 7 μm or less, 2.7 μm or less, or 1.6 μm or less. The smaller D50, the higher the composition ratio of Li₄WO₅ phase tends to be. D50 of the positive electrode active material powder may be, for example, 1.2 μm or more, 1.4 μm or more, or 1.5 μm or more. D50 of the positive electrode active material powder may be, for example, 1.2 μm to 2.7 μm.

The width of the particle size distribution may be, for example, 0.1 μm to 10 μm. That is, the minimum value (Dmin) may be 0.1 μm, and the maximum value (Dmax) may be 10 μm. The width of the particle size distribution may be, for example, 0.2 μm to 4 μm.

Coverage Rate

The positive electrode active material powder includes composite particles. The composites comprise LNO and LWO. That is, the positive electrode active material powder includes LNO and LWO. LNO is the substrate of the composites. LWO is a dressing. LWO is attached to at least a portion of the face of LNO. LWO may, for example, cover all of the face of LNO. LWO may, for example, cover a portion of the face of LNO. LWO may be distributed in islands on the face of LNO. The coverage may be, for example, 11% or more, 12% or more, 14% or more, 16% or more, or 18% or more. The coverage may be, for example, 25% or less, or 22% or less. When the coverage is 11% to 25% or less, Li₄WO₅ phase composition ratio tends to be high.

The shape of the composite particles is arbitrary. The composite particles may have, for example, a spherical shape, an ellipsoid shape, a flake shape, a columnar shape, or the like.

### Lithium Tungsten Composite Oxide

LWO may have the effect of protecting the nascent surface of LNO. On the face of LNO, LWO may be in the form of a film or in the form of particles. LWO may comprise a plurality of phases. More than 30% of LWO is Li₄WO₅ phase. The remainder of LWO excluding Li₄WO₅ phase (hereinafter may be abbreviated as “remainder”) may include, for example, Li₂WO₄ phase. LWO may include, for example, 30% or more of Li₄WO₅ phase, and the remaining Li₂WO₄ phase. For example, the ratio of Li₄WO₅ phase to the sum of Li₄WO₅ phase and Li₂WO₄ phase may be 30% or more.

The remainder is, for example, Li₆WO₆ phase, Li₂W₄O₁₃ phase, Li₂W2O₇ phase, Li₆W₂O₉ phase, Li₂W₂O₇ phase, Li₂W₅O₁₆ phase, Li₉W₁₉O₅₅ phase, Li₃W₁₀O₃₀ phase, Li₁₈W₅O₁₅ phase, and the like. Li₄WO₅ phase and Li₂WO₄ phase the composition ratio of the phase other than the phase may be, for example, 10% or less, 5% or less, 1% or less, or 0.1% or less in total.

When the composition ratio of Li₄WO₅ phase is 30% or more, an improvement in the capacity retention ratio is expected. The composition ratio of Li₄WO₅ phase may be, for example, 34% or more, 54% or more, 61% or more, or 63% or more. The composition ratio of Li₄WO₅ phase may be, for example, 71% or less, 66% or less, or 64% or less. LWO may include, for example, 54% or more of Li₄WO₅ phase, and the remaining Li₂WO₄ phase. LWO may include, for example, 54-71% Li₄WO₅ phase, and the remaining Li₂WO₄ phase.

Lithium Nickel Composite Oxide

LNO undergoes a positive electrode response. LNO may have any crystalline configuration. LNO may have, for example, a layered rock salt-type construction. LNO includes a Li, a Ni, and O. LNO may consist of Li, a Ni, and O. LNO is a host-guest system. Ni and O may form a host-structure. Li behaves as a guest. The host-structure may contain additional atoms in addition to Ni and O. The host-structure may include, for example, at least one selected from the group consisting of Co, Mn, and Al. However, Ni ratio of LNO is 0.5 or more. When Ni ratio is 0.5 or more, the composition ratio of Li₄WO₅ phase tends to increase. Ni ratio may be, for example, 0.6 or more, 0.7 or more, 0.8 or more, or 0.9 or more.

LNO may be represented by, for example, the following formula (1).

Li₍₁₊ₓ₎Ni_{y}Co_{z}Mn_{(1-y-z)}MₐO_{(2-b)}C_{b} (1)

In the above formula (1), x, y, z, a, and b satisfy the relationship of 0≤x≤0.7, 0.5≤y≤0.8, 0.1≤z≤0.2, 0≤a≤0.1, and 0≤b≤0.5.
M is at least one selected from the group consisting of Zr, Mo, W, Mg, Ca, Na, Fe, Cr, Zn, Si, Sn, Al, and Ag.
C is at least one selected from the group consisting of F, Cl, and Br.

In the above formula (1), y, for example, may satisfy 0.5≤y≤0.6, 0.6≤y≤≤0.7, or 0.7≤y≤0.8.

Generally, LNO may be a secondary particle in which a large amount of primary particles are aggregated. LNO may typically comprise 100 or more primary particulates. LNO in the present embodiment is crushed. The secondary particles after crushing consist of a relatively small amount of primary particles. LNO may be crushed to the primary particle-level. The secondary particles after crushing may be composed of, for example, 30 or less, 20 or less, 10 or less, 5 or less, or 3 or less primary particles. The primary particles may be present alone. The number of primary particles contained in the secondary particles can be measured in Scanning Electron Microscope (SEM) images of the positive electrode active material powder. In SEM images, for example, when two primary particles overlap, the primary particles on the back side are not confirmed. However, in the present embodiment, the number that can be confirmed in SEM images is regarded as the number of primary particles included in the secondary particles.

The primary particles may have any shape. The primary particles may be, for example, spherical, ellipsoidal, flake-like, columnar, or the like.

Method for Producing Positive Electrode Active Material Powder

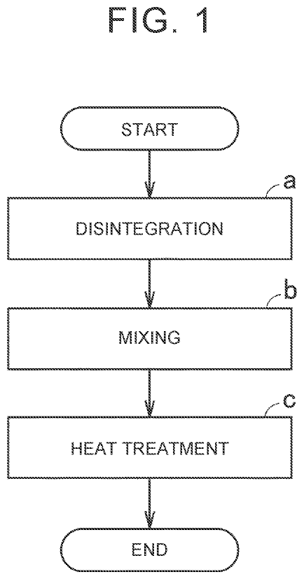

FIG. 1 is a schematic flowchart of a method for producing a positive electrode active material powder according to the present embodiment. Hereinafter, the “method for producing a positive electrode active material powder according to the present embodiment” may be abbreviated as “the present production method”. The process comprises “(a) disintegration”, “(b) mixing” and “(c) heat treatment”.

(a) Disintegration

The process includes preparing a crushed powder by crushing LNO. When LNO is disintegrated, a new surface may be generated. That is, the disintegrated powder comprises a nascent surface. LNO may be prepared in any manner. For example, LNO may be synthesized by a coprecipitation method. For example, LNO can be synthesized in the following manner.

Sulfates such as Ni are prepared. The sulfate is dissolved in water to form an acidic aqueous solution. For example, nickel sulfate, cobalt sulfate, and manganese sulfate may be dissolved in water to form an acidic aqueous solution. For example, a neutralization reaction may occur by dropping an aqueous alkali solution into an aqueous acidic solution. The alkaline aqueous solution may include, for example, an aqueous NaOH solution and an ammoniacal solution. A neutralization reaction may form a precipitate. The precipitate is believed to comprise a complex hydroxide (precursor). The precipitate is washed and dried to form a dry matter. The mixture is formed by mixing the dried product with the lithium compound. The lithium compound may include, for example, Li₂CO₃, LiOH. The mixture is subjected to a heat treatment. The heat treatment may also be referred to as “calcination.” The heat treatment temperature may be, for example, 500° C. to 1000° C. The heat treatment time may be, for example, 5 hours to 30 hours. From the above, LNO is synthesized.

Any crushing device may be used in the present manufacturing method. For example, a jet mill or the like may be used. For example, the crushing treatment may be performed under an inert gas atmosphere. For example, the crushing treatment may be performed under a nitrogen atmosphere. By performing the crushing process in an inert gas atmosphere, Li₄WO₅ phase tends to be generated. For example, the crushed powder may be further subjected to a classification treatment, a sizing treatment, and the like.

(b) Mixing

The process comprises preparing the mixture by mixing the crushed powder and WO₃. As a result, WO₃ may adhere to at least a part of the new surface generated by the disintegration. WO₃ is the precursors of LWO. D50 of WO₃ may be smaller than, for example, D50 of the crushed powder. D50 of WO₃ may be, for example, 0.1 μm to 2.7 μm, or 0.5 μm to 1 μm. The blending amount of WO₃ may be, for example, 0.1 to 2 parts by material, or 0.5 to 1 part by material with respect to LNO of 100 parts by material. Parts of material are also referred to as “molar parts”.

The mixing method is optional. For example, wet mixing or dry mixing may be performed. For example, a ball mill, a mechanofusion apparatus, or the like may be used.

(c) Heat Treatment

The method includes producing a positive electrode active material powder by subjecting the mixture to a heat treatment. Due to the heat treatment, active Li in the nascent plane can react with WO₃. As a result, it is considered that LWO is generated. In the production method, any heat treatment device can be used. For example, an electric furnace, a muffle furnace, or the like may be used. The heat treatment temperature may be, for example, 200° C. to 700° C. The heat treatment time may be, for example, 1 hour to 10 hours.

Li₄WO₅ phases tend to be generated in Li rich reactive systems. In this manufacturing process, various conditions are combined so that the composition ratio of Li₄WO₅ phase in LWO is 30% or more. As factors affecting the composition ratio of Li₄WO₅ phase, for example, “Ni ratio of LNO”, “crushing level (D50 after crushing)”, “WO₃ blending amount”, “heat treatment temperature”, and “heat treatment time” can be considered.

A Lithium Ion Battery

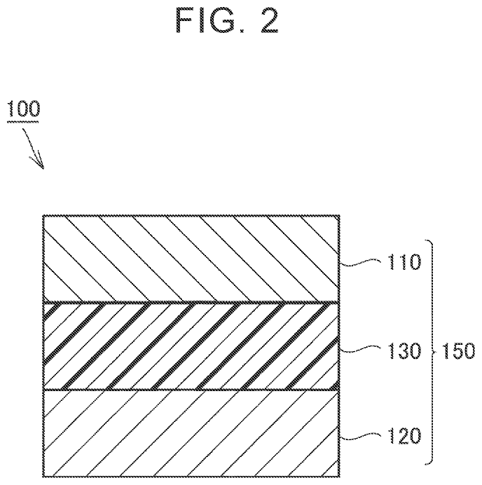

FIG. 2 is a conceptual diagram of a lithium ion battery according to the present embodiment. Hereinafter, the “lithium ion battery in the present embodiment” may be abbreviated as “the present battery”. The battery 100 may be a liquid-based battery, a polymer battery, or an all-solid-state battery. That is, the battery 100 may include a liquid electrolyte, a gel electrolyte, or a solid electrolyte.

The battery 100 may include an exterior body (not shown). The outer casing may house the power generation element 150. The sheath may have any form. The outer casing may be, for example, a pouch made of a metal foil laminate film or a case made of metal. The case may be, for example, cylindrical or square.

The battery 100 includes a power generation element 150. The power generation element 150 includes a positive electrode 110, a separator 130, a negative electrode 120, and an electrolyte (not shown). The power generation element 150 may also be referred to as an electrode assembly, an electrode group, or the like. The power generation element 150 may be, for example, a stacked type or a wound type.

Positive Electrode

The positive electrode 110 may have, for example, a sheet shape. The positive electrode 110 may include, for example, a positive electrode current collector and a positive electrode active material layer. The positive electrode current collector may include, for example, an Al foil. The positive electrode active material layer may be disposed on the surface of the positive electrode current collector. The positive electrode active material layer includes the aforementioned positive electrode active material powder. As long as the positive electrode 110 includes the positive electrode active material powder described above, the positive electrode 110 may include an additional positive electrode active material powder. For example, the positive electrode active material layers may further include LiFePO₄. The positive electrode active material layer may further include a conductive material, a binder, and the like in addition to the positive electrode active material powder. The positive electrode active material layers may include, for example, acetylene black (AB), polyvinylidene fluoride (PVDF), and the like.

Negative Electrode

The negative electrode 120 may have, for example, a sheet shape. The negative electrode 120 may include, for example, a negative electrode current collector and a negative electrode active material layer. The negative electrode current collector may include, for example, a Cu foil. The negative electrode active material layer may be disposed on the surface of the negative electrode current collector. The negative electrode active material layer includes a negative electrode active material. The negative electrode active material may be in a powder form or a sheet form. The negative electrode active material may include, for example, at least one selected from the group consisting of natural graphite, artificial graphite, soft carbon, hard carbon, Si, SiOₓ (0<x<2), Si based alloy, Sn, SnOₓ (0<x<2), Li, Li based alloy, and Li₄Ti₅O₁₂. The negative electrode active material layer may further include a conductive material, a binder, and the like. The negative electrode active material layers may include, for example, vapor-grown carbon fiber (VGCF), carboxymethyl cellulose (CMC), styrene-butadiene rubber (SBR), and the like.

Separator

The separator 130 is interposed between the positive electrode 110 and the negative electrode 120. The separator 130 separates the positive electrode 110 from the negative electrode 120. In the case of a liquid-based battery, the separator 130 may include, for example, a porous sheet made of resin. In the case of an all-solid-state battery, the separator 130 may include, for example, a solid electrolyte layer or the like.

Electrolyte

The electrolyte may form an ion conduction path. The liquid electrolyte includes, for example, a lithium salt and a solvent. The lithium-salt may include, for example, LiPF₆. Solvents may include, for example, ethylene carbonate (EC), dimethyl carbonate (DMC), ethyl methyl carbonate (EMC), and the like. The solid-state electrolyte may include, for example, a sulfide (Li₃PS₄, etc.).

Preparation of Samples

The positive electrode active material powder according to No. 1 to 15 was produced as follows (see Tables 1 below). Hereinafter, for example, “positive electrode active material powder related to No. 1” or the like may be abbreviated as “No. 1”.

No. 1 to 4

An acidic aqueous solution was prepared by dissolving nickel sulfate, cobalt sulfate, and manganese sulfate in water. The blending ratio (material ratio) of the solute was “nickel sulfate/cobalt sulfate/manganese sulfate=5/2/3”. The mass ratio is also referred to as the “molar ratio”. An aqueous NaOH solution and an aqueous ammonia solution were added dropwise to the acidic aqueous solution to form a precipitate. The precipitate contained complex hydroxides. The precipitate was washed and dried to form a dry matter. A mixture was formed by mixing the dry matter with Li₂CO₃. The mixture was subjected to a heat treatment. The heat treatment temperature was 870° C. The heat treatment time was 15 hours. From the above, LNO was synthesized. No. 1 to 4 (crushed powder) was produced by subjecting LNO to a crushing treatment and a classification treatment. No. 1 to 4 differ in crushing conditions.

No. 5

LNO was synthesized in the same manner as No. 1, except that the blending ratio (material ratio) of the solute was changed to “nickel sulfate/cobalt sulfate/manganese sulfate=6/2/2”. No. 5 was produced by subjecting LNO to a crushing treatment and a classification treatment.

No. 6

LNO was synthesized in the same manner as in No. 1, except that the blending ratio (material ratio) of the solute was changed to “nickel sulfate/cobalt sulfate/manganese sulfate=8/1/1”. No. 6 was produced by subjecting LNO to a crushing treatment and a classification treatment.

No. 7

Mixtures were prepared by mixing LNO of No. 1 (crushed powder) with WO₃ (D50=1 μm). The blending ratio (material amount ratio) was “LNO/WO₃=100/0.5”. The mixture was subjected to a heat treatment. The heat treatment temperature was 500° C. The heat treatment time was 4 hours. As described above, the positive electrode active material powder was produced.

No. 8 to 10, 14 and 15

A positive electrode active material powder was prepared in the same manner as in No. 7, except that LNO of No. 2 to 6 (crushed powder) was used instead of LNO of No. 1 (crushed powder).

No. 11

Li of the nascent surface was reduced by washing LNO (crushed powder) of No. 4 with water. A positive electrode active material powder was prepared in the same manner as in No. 10 except that the pulverized powder after washing with water and WO₃ were mixed.

No. 12

A positive electrode active material powder was prepared in the same manner as in No. 10, except that the blending ratio (material amount ratio) of LNO and WO₃ was changed to “LNO/WO₃=100/0.75”.

No. 13

A positive electrode active material powder was prepared in the same manner as in No. 10, except that the blending ratio (material amount ratio) of LNO and WO₃ was changed to “LNO/WO₃=100/1”.

Evaluation

In the positive electrode active material powders, Li₄WO₅ phase and Li₂WO₄ phase constituent ratios were measured. The measurements are shown below in Tables 1 to 4.

Test cells for evaluation were made. The configuration of the test battery was as follows.

Positive Electrode

Positive electrode active material powder: Sample (No. 1 to 15) obtained above
Conductive material: AB
Binder: PVDF

Negative Electrode
Negative electrode active material: Natural graphite
Binder: CMC, SBR

Separator: Porous sheet (24 μm thick)
Electrolyte: electrolyte [LiPF₆ (1 mol/L), EC+DMC+EMC]

A high temperature storage test was performed. The storage temperature was 70° C. The capacity retention after storage was measured. The capacity retention ratio indicates a ratio of the storage capacity to the storage capacity before storage. The measurements are shown below in Tables 1 to 4.

Results and Discussion

TABLE 1
Table 1 Sample list

| | | | | | | High |
|---|---|---|---|---|---|---|
| | Positive electrode active material powder | | | | | Temperature |
| | | | LWO | | | Storage Test |
| | | | XAFS | | XPS | Capacity |
| | | | Li₄WO₅ | Li₂WO₄ | Coating | maintaining |
| | D50 | | phase | phase | ratio | rate |
| No. | [μm] | LNO | [%] | [%] | [%] | [%] |
| 1 | 7 | LiNi_{0.5}Co_{0.2}Mn_{0.3}O₂ | 0 | 0 | 0 | 81 |
| 2 | 2.7 | LiNi_{0.5}Co_{0.2}Mn_{0.3}O₂ | 0 | 0 | 0 | 75 |
| 3 | 1.5 | LiNi_{0.5}Co_{0.2}Mn_{0.3}O₂ | 0 | 0 | 0 | 72 |
| 4 | 1.2 | LiNi_{0.5}Co_{0.2}Mn_{0.3}O₂ | 0 | 0 | 0 | 70 |
| 5 | 1.4 | LiNi_{0.6}Co_{0.2}Mn_{0.2}O₂ | 0 | 0 | 0 | 68 |
| 6 | 1.6 | LiNi_{0.8}Co_{0.1}Mn_{0.1}O₂ | 0 | 0 | 0 | 66 |
| 7 | 7 | LiNi_{0.5}Co_{0.2}Mn_{0.3}O₂ | 34 | 66 | 18 | 84 |
| 8 | 2.7 | LiNi_{0.5}Co_{0.2}Mn_{0.3}O₂ | 63 | 37 | 16 | 80 |
| 9 | 1.5 | LiNi_{0.5}Co_{0.2}Mn_{0.3}O₂ | 64 | 36 | 14 | 79 |
| 10 | 1.2 | LiNi_{0.5}Co_{0.2}Mn_{0.3}O₂ | 71 | 29 | 11 | 80 |
| 11 | 1.2 | LiNi_{0.5}Co_{0.2}Mn_{0.3}O₂ | 30 | 70 | 12 | 72 |
| 12 | 1.2 | LiNi_{0.5}Co_{0.2}Mn_{0.3}O₂ | 61 | 39 | 22 | 79 |
| 13 | 1.2 | LiNi_{0.5}Co_{0.2}Mn_{0.3}O₂ | 54 | 46 | 25 | 75 |
| 14 | 1.4 | LiNi_{0.6}Co_{0.2}Mn_{0.2}O₂ | 63 | 37 | 14 | 76 |
| 15 | 1.6 | LiNi_{0.8}Co_{0.1}Mn_{0.1}O₂ | 66 | 34 | 12 | 75 |

TABLE 2
Tables 2 D50, Li₄WO₅ phase composition ratio

| | | | | | | High |
|---|---|---|---|---|---|---|
| | Positive electrode active material powder | | | | | Temperature |
| | | | LWO | | | Storage Test |
| | | | XAFS | | XPS | Capacity |
| | | | Li₄WO₅ | Li₂WO₄ | Coating | maintaining |
| | D50 | | phase | phase | ratio | rate |
| No. | [μm] | LNO | [%] | [%] | [%] | [%] |
| 1 | 7 | LiNi_{0.5}Co_{0.2}Mn_{0.3}O₂ | 0 | 0 | 0 | 81 |
| 2 | 2.7 | LiNi_{0.5}Co_{0.2}Mn_{0.3}O₂ | 0 | 0 | 0 | 75 |
| 3 | 1.5 | LiNi_{0.5}Co_{0.2}Mn_{0.3}O₂ | 0 | 0 | 0 | 72 |
| 4 | 1.2 | LiNi_{0.5}Co_{0.2}Mn_{0.3}O₂ | 0 | 0 | 0 | 70 |
| 7 | 7 | LiNi_{0.5}Co_{0.2}Mn_{0.3}O₂ | 34 | 66 | 18 | 84 |
| 8 | 2.7 | LiNi_{0.5}Co_{0.2}Mn_{0.3}O₂ | 63 | 37 | 16 | 80 |
| 9 | 1.5 | LiNi_{0.5}Co_{0.2}Mn_{0.3}O₂ | 64 | 36 | 14 | 79 |
| 10 | 1.2 | LiNi_{0.5}Co_{0.2}Mn_{0.3}O₂ | 71 | 29 | 11 | 80 |

In the above Table 2, the smaller D50 after crushing, Li₄WO₅ phase composition ratio tends to be higher. It is considered that the smaller D50 after crushing, the more the new surface is increased, and the more the reaction system rich in Li is easily formed. The higher the composition ratio of Li₄WO₅ phase, the more likely it is to improve the capacity retention ratio.

### Table 3

TABLE 3
Tables 3 WO₃ Coating quantity, coating ratio

| | | | | | | High |
|---|---|---|---|---|---|---|
| | Positive electrode active material powder | | | | | Temperature |
| | | | LWO | | | Storage Test |
| | | | XAFS | | XPS | Capacity |
| | | | Li₄WO₅ | Li₂WO₄ | Coating | maintaining |
| | D50 | | phase | phase | ratio | rate |
| No. | [μm] | LNO | [%] | [%] | [%] | [%] |
| 10 | 1.2 | LiNi_{0.5}Co_{0.2}Mn_{0.3}O₂ | 71 | 29 | 11 | 80 |
| 11 | 1.2 | LiNi_{0.5}Co_{0.2}Mn_{0.3}O₂ | 30 | 70 | 12 | 72 |
| 12 | 1.2 | LiNi_{0.5}Co_{0.2}Mn_{0.3}O₂ | 61 | 39 | 22 | 79 |
| 13 | 1.2 | LiNi_{0.5}Co_{0.2}Mn_{0.3}O₂ | 54 | 46 | 25 | 75 |

Remarks
No. 10: LNO/WO₃ = 100/0.50 (by volume)
No. 11: LNO/WO₃ = 100/0.50 (material ratio) LNO washing
No. 12: LNO/WO₃ = 100/0.75 (by volume)
No. 13: LNO/WO₃ = 100/1.00 (by volume)

In the above-described Tables 3, the active Li is reduced by washing with water after crushing, so that the composition ratio of Li₄WO₅ phase tends to decrease (No. 11).

In the above-described Tables 3, the coating ratio is increased by increasing the blending amounts of WO₃ (No. 10, 12, 13). On the other hand, Li₄WO₅ phase composition ratio is gradually decreasing. It is considered that the quantitative balance between WO₃ and Li is changed by increasing the blending amount of WO₃. When the coverage ratio exceeds 22%, the effect of improving the capacity retention ratio is reduced. It is considered that the generation frequency of Li₄WO₅ phase is reduced due to the shortage of Li.

TABLE 4
4 Ni ratio

| | | | | | | High |
|---|---|---|---|---|---|---|
| | Positive electrode active material powder | | | | | Temperature |
| | | | LWO | | | Storage Test |
| | | | XAFS | | XPS | Capacity |
| | | | Li₄WO₅ | Li₂WO₄ | Coating | maintaining |
| | D50 | | phase | phase | ratio | rate |
| No. | [μm] | LNO | [%] | [%] | [%] | [%] |
| 4 | 1.2 | LiNi_{0.5}Co_{0.2}Mn_{0.3}O₂ | 0 | 0 | 0 | 70 |
| 5 | 1.4 | LiNi_{0.6}Co_{0.2}Mn_{0.2}O₂ | 0 | 0 | 0 | 68 |
| 6 | 1.6 | LiNi_{0.8}Co_{0.1}Mn_{0.1}O₂ | 0 | 0 | 0 | 66 |
| 10 | 1.2 | LiNi_{0.5}Co_{0.2}Mn_{0.3}O₂ | 71 | 29 | 11 | 80 |
| 14 | 1.4 | LiNi_{0.6}Co_{0.2}Mn_{0.2}O₂ | 63 | 37 | 14 | 76 |
| 15 | 1.6 | LiNi_{0.8}Co_{0.1}Mn_{0.1}O₂ | 66 | 34 | 12 | 75 |

In the above-described Tables 4, when Ni ratio of LNO is 0.5 or more, it does not depend on Ni ratio, and the capacity retention ratio is improved.

What is claimed is:

1. A positive electrode active material powder comprising:
lithium nickel composite oxide; and
lithium tungsten composite oxide, wherein:
a ratio of an amount of substance of Ni to a total amount of substance of atoms other than Li and oxygen in the lithium nickel composite oxide is 0.5 or more;
the lithium tungsten composite oxide is adhered to at least a portion of a surface of the lithium nickel composite oxide; and
30% or more of the lithium tungsten composite oxide consists of a Li₄WO₅ phase.

2. The positive electrode active material powder according to claim 1, wherein the lithium tungsten composite oxide includes 54% or more of the Li₄WO₅ phase and a remainder of a Li₂WO₄ phase.

3. The positive electrode active material powder according to claim 1, wherein:
the lithium nickel composite oxide is represented by the following formula (1):
Li₍₁₊ₓ₎Ni_{y}Co_{z}Mn_{(1-y-z)}MₐO_{(2-b)}C_{b} (1); and
in the above formula (1),
x, y, z, a, and b satisfy relationships of 0≤x≤0.7, 0.5≤y≤0.8, 0.16≤z≤0.2, 0≤a≤0.1, and 0≤b≤0.5, respectively,
M is at least one selected from the group consisting of Zr, Mo, W, Mg, Ca, Na, Fe, Cr, Zn, Si, Sn, Al, and Ag, and
C is at least one selected from the group consisting of F, Cl, and Br.

4. The positive electrode active material powder according to claim 3, wherein:
a coverage rate of the surface of the lithium nickel composite oxide with the lithium tungsten composite oxide is 11% to 25%;
the coverage rate is obtained by the following formula (2):
θ=r_{w}/(r_{w}+r_{Ni}+r_{Co}+r_{Mn}) (2); and
in the above formula (2),
θ represents the coverage rate,
r_{w}, r_{Ni}, r_{Co}, and r_{Mn} are measured by X-ray photoelectron spectroscopy,
r_{w} represents an atomic ratio of W,
r_{Ni} represents an atomic ratio of Ni,
r_{Co} represents an atomic ratio of Co, and
r_{Mn} represents an atomic ratio of Mn.

5. The positive electrode active material powder according to claim 1, further comprising D50 of 1.2 μm to 2.7 μm.

6. A positive electrode comprising the positive electrode active material powder according to claim 1.

7. A lithium ion battery comprising the positive electrode according to claim 6.

8. A method for producing a positive electrode active material powder, comprising:
(a) preparing a crushed powder by crushing lithium nickel composite oxide;
(b) preparing a mixture by mixing the crushed powder and WO₃; and
(c) producing the positive electrode active material powder by subjecting the mixture to a heat treatment, wherein:
the positive electrode active material powder includes the lithium nickel composite oxide and lithium tungsten composite oxide;
a ratio of an amount of substance of Ni to a total amount of substance of atoms other than Li and oxygen in the lithium nickel composite oxide is 0.5 or more;
the lithium tungsten composite oxide is adhered to at least a portion of a surface of the lithium nickel composite oxide; and
30% or more of the lithium tungsten composite oxide consists of a Li₄WO₅ phase.
